(19) United States
(12) Patent Application Publication
(10) Pub. No.: US 2024/0384163 A1
(43) Pub. Date: Nov. 21, 2024

(54) USE OF MICROCAPSULES COMPOSED OF AN OIL-BASED DRAG-REDUCING POLYMER (DRP) IN ITS INTERNAL PHASE IN OIL AND GAS PRODUCTION FIELDS

(71) Applicants: PETRÓLEO BRASILEIRO S.A. - PETROBRAS, Rio de Janeiro (BR); PONTIFÍCIA UNIVERSIDADE CATÓLICA DO RIO DE JANEIRO, Rio de Janeiro (BR)

(72) Inventors: Marcia Cristina KHALIL DE OLIVEIRA, Rio de Janeiro (BR); Jorge AVENDANO, Rio de Janeiro (BR); Mateus Aguiar RODRIGUES DE LIMA, Copacabana (BR); Sergio Santiago RIBEIRO, Rio de Janeiro (BR); Bruna Costa LEOPÉRCIO, Rio de Janeiro (BR); Márcio DA SILVEIRA CARVALHO, Rio de Janeiro (BR); Carmen Lucia DA SILVA TEIXEIRA, Rio de Janeiro (BR)

(21) Appl. No.: 18/640,639

(22) Filed: Apr. 19, 2024

(30) Foreign Application Priority Data
May 17, 2023 (BR) 1020230095216

(51) Int. Cl. C09K 8/92; C09K 8/82; E21B 43/01

(52) U.S. Cl. CPC C09K 8/92; C09K 8/82; E21B 43/01; C09K 2208/28

(57) ABSTRACT

The present invention proposes the use of a microcapsule composed of an oil-based drag-reducing polymer (DRP) as an internal phase and an external membrane composed of a thermosensitive material impermeable to the drag-reducing polymer in oil production fields, more specifically, in subsea umbilicals. The external membrane of the microcapsules is ruptured when exposed to an environment with a temperature above the temperature of the oil being produced, releasing its internal contents into the flowing oil.

### FIELD OF THE INVENTION

The present invention pertains to the technical field of lifting and flowing technologies, more specifically, flowing in transfer oil pipelines and pre-salt oil and gas producing wells that present very high production flow rates.

### BACKGROUNDS OF THE INVENTION

The transport of liquids through pipes is one of the countless applications of fluid mechanics in engineering and much has been studied on this subject over the years, due to its economic importance, since, in systems involving fluid flows, especially turbulent ones, there are energy losses that reduce the efficiency and increase the operating costs. When transporting fluids in long-distance pipes, for example, energy loss can reach almost 100% (WILLEMSENS, 2013). In this sense, it is necessary to search for solutions that minimize the costs of this type of operation.

Every fluid that flows through a piping is subjected to shear stresses caused by friction with the piping walls, especially in flows with a high Reynolds number, where the pressure loss is more pronounced, thus generating greater energy dissipation. In an attempt to reduce these energy losses, some scholars have dedicated themselves to researching ways to reduce drag in piping through the addition of polymers to the flowing fluid or through changes in the geometry of the piping surface. All investment in reducing pressure loss is justified, since, in some cases, this reduction in drag corresponds to 80% (COSTALONGA, 2017), and is therefore quite economically interesting.

The use of polymers as drag reducers has proven to be efficient in several applications, both in the industrial field (oil pipelines, oil fields and fire-fighting systems, for example) and in the medical field (promoting the suppression of atherosclerosis and the prevention of lethality due to hemorrhagic shock) (WANG et al., 2011).

The first systematic study on the reduction of hydrodynamic friction was published by the British chemist B. A. Toms, in 1948. Toms showed that dilute solutions of poly (methyl methacrylate), dissolved in the solvent chlorobenzene, under certain conditions of turbulent flow, presented lower pressure loss in relation to pure solvent flow. Due to his work, the phenomenon of friction reduction came to be known as the Toms Effect.

Since then, other researchers have also dedicated work to the study of drag reduction, such as Savins (1964), who quantitatively evaluated the drag reduction in pipes with turbulent flow using macromolecule solutions and also investigated the modes of interaction between the polymer chain and turbulence.

Metzner and Park (1964) also quantitatively studied the turbulent flow characteristics of viscoelastic fluids.

The drag reduction can also be achieved by changing the geometry of the internal surface of ducts, as shown by Willemsens (2013), who investigated the reduction of drag in turbulent flow in a square-section pipe by printing small longitudinal grooves in its interior called riblets. However, this type of study is not the focus of the present invention.

The expression ‘reduction in drag or hydrodynamic friction’ is used in the literature to designate the reduction in the pressure gradient observed in turbulent flows in pipes, resulting from the addition of small amounts of certain substances to the liquid phase. Experiments indicate that the reduction in drag is due to the change in the structure of the turbulence. Most theoretical and experimental studies in this field are associated with the effects of dilute polymer solutions, on the order of 50 ppm to 200 ppm.

In pre-salt wells with high production flow rate, there were also observed higher-than-expected pressure losses. To overcome this problem, the feasibility of using polymers together with fluids was evaluated to reduce flow drag through the production lines, thus allowing the production flow rate to be increased with the use of existing pumping installations, defined in the project.

The Oil & Gas industry traditionally uses hydrodynamic friction reducing polymers (Drag Reducer Agent-DRA) in long-distance transport of fluids, in a single-phase flow regime. In these cases, the friction factor can be reduced by up to 70% by adding DRA. As a general rule, DRA products are high molecular weight polymers that have high viscosity and good solubility in the working fluid.

In the oil industry, one of the most significant applications of polymers in reducing friction is in the oil pipeline that crosses the state of Alaska-USA from Prudhoe Bay, where the producing field is located, to Valdez Bay, where the oil is transferred to ships. This oil pipeline has a nominal diameter of 48 inches (1.23 m), is 1,287 km long and has 12 pumping stations. In its operation, approximately 30% increase in mass flow rate is obtained by injecting 10 ppm of polymer downstream of each pumping station.

Another example, with satisfactory results from the application of DRA, was published by Compañia Logística de Hidrocarburos, in Spain, where around 20 ppm were injected into a diesel pipeline, obtaining a 45.3% reduction in friction.

The potential use of DRAs not only applies to the flow of oil, but also to the flow of its derivatives and the biofuels. Therefore, for each type of working fluid, a there is required polymer that presents adequate solubility in the medium. Additionally, the friction reduction is attractive in emergency or preventative production maintenance situations, where the aim is to somehow increase the flow rate of a given pipeline to compensate for the absence or operational deficiency of another pumping or flowing system.

Polymers, surfactants, suspension of insoluble particles, such as fine grains or fibers, and polymers mixed with soaps or fibers are some types of agents that produce hydrodynamic friction reduction. Some natural polymers, such as polysaccharides, DNA, collagen and some gums (such as guar gum and xanthan) also produce this effect; however, they normally require a higher concentration to obtain the same effect, when compared to the linear synthetic polymers with high molar mass (on the order of 106 gmol⁻¹), as described by Bisotto, 2011.

The most studied polymers in aqueous systems are poly (ethylene oxide) (PEO) and polyacrylamide (PAM). Rates of up to 80% friction reduction can be achieved for these systems under certain flow conditions. As for organic solvents, the most studied polymers are polyisobutylene (PIB), polyolefins and polystyrene (PS).

The temperature of the medium is another variable that affects the polymer ability to reduce hydrodynamic friction, as it changes the macromolecular conformation and, consequently, the interaction of the polymer chains with turbulence.

Despite the significant drag reduction results for oil-based polymers, there are major operational challenges for injecting these products. Due to the high instability, these products must be homogenized in appropriate tanks before the injection, the product pumping system must be specific for a high viscosity fluid, and the product storage location must be close to the injection point.

A disadvantage of the friction reducing agents is related to the mechanical scission of the polymer molecular chain (mechanical degradation) that occurs when the added fluid travels through regions of high shear (centrifugal pump) and, consequently, the reduction of the Toms Effect. Another disadvantage is the high viscosity of these products under typical low temperature conditions in subsea injection systems.

To overcome these issues, there are several studies considering surfactant products, replacing polymers, for application as hydrodynamic friction reducers. The surfactants at a certain temperature produce long micelles that are capable of restoring the macromolecular structure very quickly after some scission. In addition, they form stable, low-viscosity solutions. However, much lower performance results were observed (five times lower), when compared to those obtained by conventional polymeric molecules (Pinerri, 2017).

In deepwater production scenarios, the oil-based drag-reducing polymer (DRP) must be pumped through subsea umbilicals to the head of producing wells to be dispersed in the oil during flow and lift in the production line. Due to the low flow temperature along the umbilicals (around 4° C.) and the limitation of the chemical pumping systems, the conventional drag-reducing polymers on the market are not applicable, as they have very high viscosity and instability, with great potential for formation of aggregates and obstruction of the injection line. These two aspects make the pressure loss and pumping power of the polymers along the subsea umbilicals so high that they make the use of drag-reducing polymers in this application unfeasible.

An alternative to meet this demand and further reduce the operational challenges of injecting conventional DRAs was to evaluate the possibility of microencapsulation of conventional polymers, followed by dispersion of the microcapsules in a low viscosity solvent, generating a formulation capable of being injected via subsea umbilical and being functionalized to release the polymer, when in contact with hot oil, promoting the adequate friction reduction.

The patents of “Baker Hughes Incorporated” originating from international publications WO 99/37396 and WO 03/004146, and already in the public domain, address to the encapsulation of drag-reducing polymers but with a different proposal from that presented in the present invention. According to the authors, the capsule or its casing can be removed before, during or after the capsules are flowing, and the focus is on the encapsulation of monomers that will be polymerized into DRP or the encapsulation of a suspension or paste of DRP in a carrier, with the objective of avoiding the formation of lumps when transporting the polymer to the injection site.

In the present invention, the focus is on the use of the microencapsulation of conventional polymers followed by the dispersion of the microcapsules in a low viscosity solvent, generating a formulation capable of being injected via a subsea umbilical and being functionalized to release the polymer, when in contact with hot oil, promoting the adequate reduction of friction in fluid transport.

In Baker's two patents, the capsules are suspended in an aqueous medium, which will be responsible for dissolving the capsule membrane, releasing the internal contents (drag-reducing polymer) into the medium. On some occasions, the suspension must be heated to accelerate the membrane dissolution, and there may be production and phase separation problems.

In the proposed invention, the microcapsules are suspended in an oily medium (low viscosity solvent), thus avoiding the addition of water to the produced oil.

In Baker's two patents, the membrane of the capsules is dissolved when they are suspended in an aqueous medium. Meanwhile, in the proposed invention, the high temperature of the oil being produced is responsible for dissolving the membrane and releasing the drag-reducing polymer into the medium. The internal contents (drag-reducing polymer) is protected until the moment of contact with the oil that is being produced at a high temperature and capable of rupturing the capsule.

The biggest gain and the main advantage of using the DRP polymer in microcapsules is the ease of transporting the drag-reducing polymer as a low viscosity product to the place where it must be made available in the oily phase flow, thus preventing the particles from agglomerating or the clogging of the product injection line to occur. Furthermore, the use of the DRP polymer in microcapsules makes it possible to pump the polymer through subsea umbilicals, where the fluid is exposed to very low temperatures and, consequently, presents a very high viscosity.

### SUMMARY OF THE INVENTION

The present invention proposes the use of a microcapsule composed of an oil-based drag-reducing polymer (DRP) as the internal phase and an external membrane composed of a thermosensitive material impermeable to the drag-reducing polymer in oil production fields, more specifically, in subsea umbilicals.

The external membrane of the microcapsules is ruptured when exposed to an environment with a temperature above the temperature of the oil produced, releasing its internal contents into the flowing oil.

### BRIEF DESCRIPTION OF THE FIGURES

The patent or application file contains at least one drawing executed in color. Copies of this patent or patent application publication with color drawings(s) will be provided by the Office upon request and payment of the necessary fee.

FIG. 1 is an illustration of the process of transporting microencapsulated drag-reducing polymer through the subsea umbilical and its release into the fluid being transported.

FIG. 2 is the microscope visualization of the capsules containing the oil-based drag-reducing polymer of the present invention at room temperature (on the left) and at a temperature of 4° C. (on the right).

FIG. 3 is the microscope visualization of the capsules containing the oil-based drag-reducing polymer of the present invention at ambient pressure (on the left) and after pressurization at 3000 psi (20.68 MPa) (on the right).

FIG. 4 shows the evolution of the rupture of the membranes of the capsules of the present invention and the release of the drag-reducing polymer from inside the capsules, when exposed to an environment with a temperature of 75° C.

FIG. 5 is a graph of the variation in apparent viscosity versus Hencky strain for kerosene samples without capsules (pure and with 25 ppm, 50 ppm, 100 ppm and 200 ppm of drag-reducing polymer) and with capsules (after 60 min and 120 min of adding capsules).

### DETAILED DESCRIPTION OF THE INVENTION

The present invention contemplates the transport of oil-based drag-reducing polymers encapsulated in subsea umbilicals. The oil-based drag-reducing polymer (DRP) corresponds to the internal phase of the microcapsule.

The present invention proposes the encapsulation of commercial, ready-to-use DRP, which, when released, changes the properties of the oily medium to which it was added. The release of DRP occurs by natural heating of the system, which dissolves the polymeric casing or membrane.

In the present invention, the microcapsules are used to protect and transport the encapsulated drag-reducing polymer and allow its release in a controlled manner, at the appropriate time and place, within oil and gas exploration and production fields.

The microcapsules can be produced using different techniques and with different materials in the external membrane (casing), depending on the function they will fulfill and how they will release the encapsulated component.

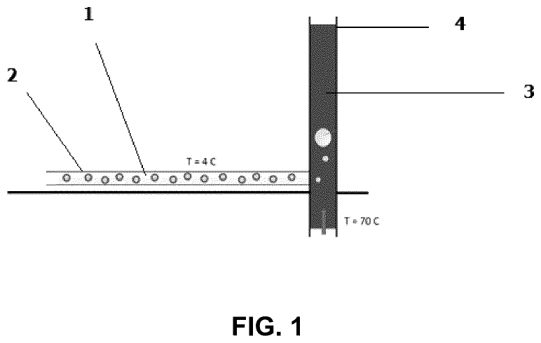

The external membrane of the microcapsules must be impermeable to the drag-reducing polymer and must be ruptured when exposed to an environment with a temperature above the temperature of the produced oil, releasing its internal contents into the oil flowing from the bottom of the well to the platform or in transfer oil pipelines. In this way, when the suspension of the injected microcapsules comes into contact with the oil flowing through the producing well, the casing of the microcapsules disintegrates, allowing the dispersion of the drag-reducing polymer in the produced oil. FIG. 1 illustrates the process of injecting a suspension of microcapsules (1) containing a drag-reducing polymer as an internal phase through the subsea umbilical (2) and releasing its contents upon contact with oil (3) in the subsea production line (4).

The use of temperature as a trigger for the destruction of microcapsules and the consequent release of the encapsulated contents is common. In general, thermosensitive materials are used to form the protective shell (casing) of the microcapsule. At room temperature, such materials are solid, but when exposed to heat (above 70° C.), they melt, releasing the internal contents. Shells made from glycerides, paraffinic oil, nonadecane, eicosane and gellan gum are some of the possible thermosensitive materials. All external membranes produced with these materials were able to release the load from the internal phase when heated.

The present invention proposes the use of microcapsules to enable the subsea injection of an oil-based drag-reducing polymer in oil and gas production fields.

The present invention proposes the use of impermeable microcapsules, produced by the microfluidic technique, in oil production fields, more specifically in subsea umbilicals.

In general, the present invention proposes the use of a microcapsule composed of an oil-based drag-reducing polymer as the internal phase and an external membrane composed of a thermosensitive material impermeable to the drag-reducing polymer in oil production fields. The chosen drag-reducing polymer must have low viscosity at low temperatures and high stability, that is, it must have a viscosity of less than 100 cP at 4° C., to facilitate handling and be able to be pumped via a subsea umbilical and still present stability at low temperatures.

The present invention also proposes, more specifically and as an embodiment of the invention, a microcapsule composed of the oil-based drag-reducing polymer polyisobutylene (PIB) of high molecular weight, in the range of 4 to 8 MM, as phase internal, and an external membrane composed of gellan gum, produced by the microfluidic technique, in subsea umbilicals.

### Results of the Invention

The experimental results showed the feasibility of producing, by microfluidics, microcapsules with an oil-based drag-reducing polymer (high molecular weight PIB) as the internal phase and the membrane composed of an aqueous polymer known as gellan gum (solution of 0.5% by mass of Kelcogel CG-LA gellan gum (CP Kelco Brasil S/A, Brazil) and 2.0% by mass of Tween 20 surfactant (Sigma-Aldrich, USA) in milli-Q water (Direct-Q3 UV System, Millipore Co., USA).

The capsules produced were initially suspended in a mixture of kerosene and 500PS oil and then only in kerosene. Kerosene acts as a solvent for the microcapsule suspension, and this suspension is added to the oil. Kerosene has a viscosity of approximately 3 cP at 4° C. A suspension of microcapsules at a concentration of around 20% by volume would present a viscosity of the order of 5 cP at 4° C., much lower than the established limit of 100 cP to enable pumping through the umbilical.

The microcapsules produced were stored in an environment at 4° C. and also exposed to this temperature in a cold bath to test their resistance in the temperature range of the flow through the umbilical.

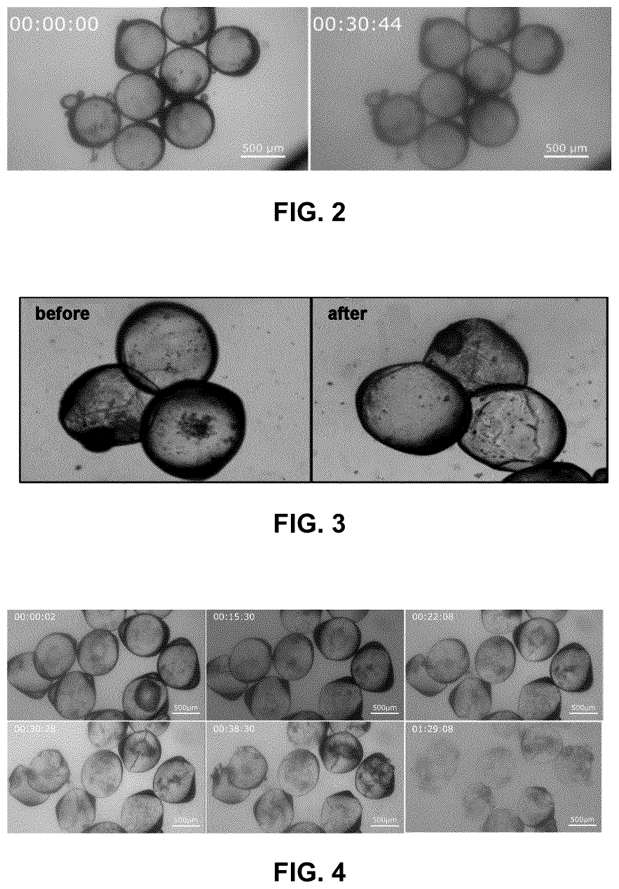

FIG. 2 shows an image of the capsules at a temperature of 4° C. A fluorescent dye was added to the internal phase to facilitate visualization of the capsules. In a more explanatory way, FIG. 2 shows the visualization of capsules containing the oil-based drag-reducing polymer (high molecular weight PIB) as the internal phase, gellan gum membrane as the external phase, suspended in kerosene at room temperature, on the left, and at a temperature of 4° C., on the right. The integrity of the capsules can be clearly observed.

### High Pressure Resistance

The same capsule tested in relation to temperature was also tested in relation to high pressures. Strength to high pressure was also verified through a pressurization test of the capsules at 3000 psi (20.68 MPa) in a cylinder. The capsules were kept suspended in kerosene inside a container that was placed in the cylinder at ambient pressure. The pressure was then raised to 3000 psi (20.68 MPa) and maintained there for 48 hours. At the end of this time, the cylinder was depressurized and the capsules remained intact, retaining the DRP, as shown in FIG. 3.

### Release of the Drag-Reducing Polymer

To analyze the release of the drag-reducing polymer at 75° C., the microcapsules produced were placed in a small container and this was immersed in a temperature-controlled bath. The bath temperature was raised to 75° C. FIG. 4 shows frames from the video taken during heating at different times. At the first instant (00:00:02), the capsules are intact and the drag-reducing polymer, in orange, is contained. After about 15 minutes, the capsule shells begin to show some cracks, when the system temperature reaches 75° C. At 22 minutes, part of the polymer begins to come out of some capsules, marking the beginning of the release of the internal contents. In the following 2 frames (00:30:28 and 00:38:30), the evolution of polymer release can be seen, which increases with time. The test was completed after 1 and a half hours, when almost all internal contents had already been released.

### Apparent Viscosity Measurements

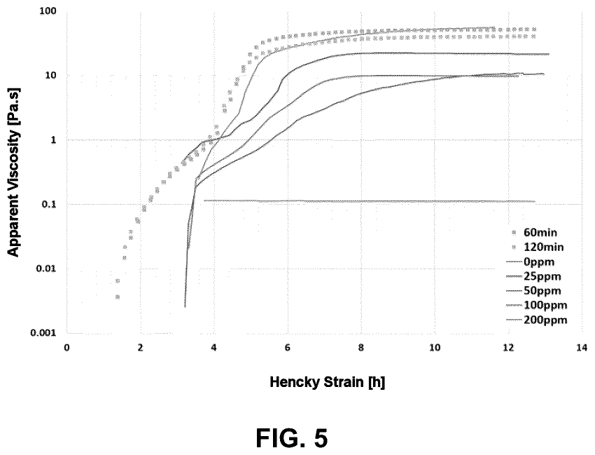

FIG. 5 shows the apparent viscosity measurements made with samples containing different concentrations of the drag-reducing polymer added directly to kerosene and microencapsulated, where the microcapsule is dissolved according to the increase in temperature. Such measurements indicate, due to the increase in viscosity, that the DRP is in fact released by the capsules, fulfilling its function as a drag reducer, given that the level of the apparent viscosity of the sample obtained from the test with capsules after 1 hour already reaches the level corresponding to a sample of kerosene with 200 ppm. This level remains after 2 hours.

This set of experimental tests indicates that it is possible to create a low viscosity microencapsulated system for injection of the drag-reducing polymer (high molecular weight PIB), which meets the conditions for subsea injection, that is, it withstands high pressures (3000 psi or 20.68 MPa) and low temperatures (4° C.), and which is capable of releasing DRP as a consequence of the increase in system temperature that already occurs as part of the process, without needing to be mixed with anything else. Capsules with an external diameter between 1.0 and 1.5 mm and an internal diameter between 0.8 and 1.4 mm were produced.

1. A use of a microcapsule comprising:
an oil-based drag-reducing polymer as an internal phase; and
an external membrane comprising a thermosensitive material,
wherein the microcapsule is configured to be applied in oil production fields, more specifically, in subsea umbilicals.

2. The use according to claim 1, wherein the oil-based drag-reducing polymer has a viscosity of less than 100 cP at 4° C.

3. The use according to claim 1, wherein the oil-based drag-reducing polymer is a high molecular weight polyisobulitene polymer.

4. The use according to claim 1,
wherein the thermosensitive material of the external membrane is impermeable to the drag-reducing polymer, and
wherein the external membrane is configured to rupture is ruptured, when exposed to an environment with a temperature above a temperature of the oil produced to release internal contents of the external membrane-into the flowing oil.

5. The use according to claim 4, wherein the thermosensitive material of the external membrane is solid at room temperature and is configured to melt when exposed to heat above 70° C. to release internal contents of the external membrane into the flowing oil.

6. The use according to claim 1, wherein the thermosensitive material of the external membrane is selected from the group consisting of glycerides, paraffinic oils, nonadecane, eicosane or gellan gum.

7. The use according to claim 1, wherein the microcapsule is composed of the oil-based drag-reducing polymer of high molecular weight as the internal phase, gellan gum as the external membrane, and wherein the microcapsule is used in subsea umbilicals.

8. The use according to claim 1, wherein the external membrane is stable under high pressure conditions.
